(19) United States
(12) Patent Application Publication
(10) Pub. No.: US 2025/0138608 A1
(43) Pub. Date: May 1, 2025

(54) DISPLAY DEVICE, CONTROL METHOD OF DISPLAY DEVICE AND NON-TRANSITORY COMPUTER READABLE MEDIUM

(71) Applicant: CANON KABUSHIKI KAISHA, Tokyo (JP)

(72) Inventor: YOTA ITO, Tokyo (JP)

(21) Appl. No.: 18/911,736

(22) Filed: Oct. 10, 2024

(30) Foreign Application Priority Data
Oct. 27, 2023 (JP) 2023-184704

(51) Int. Cl. G06F 1/20; G02B 7/02; G06F 1/16

(52) U.S. Cl. CPC G06F 1/206; G02B 7/028; G06F 1/1656

(57) ABSTRACT

A display device includes a casing; a display unit that is disposed in the casing; a temperature detecting unit configured to detect temperature on a front face side, where an image is displayed, of the display unit; an exhaust heat control unit configured to conduct exhaust heat generated on a rear face side of the display unit to the front face side of the display unit; and a temperature control unit configured to control conduction of the exhaust heat by the exhaust heat control unit, based on the temperature detected by the temperature detecting unit.

### BACKGROUND OF THE INVENTION

### Field of the Invention

A technique of the present disclosure relates to a display device, more particularly to a display device used for an XR device, and a control method of the display device.

### Description of the Related Art

In recent years the development of XR devices, such as a head mounted display and smart glasses, is actively progressing, to which such XR techniques as virtual reality (VR), augmented reality (AR), and mixed reality (MR) are applied. The Japanese Translation of PCT Application No. 2018-509983 discloses an ophthalmologic system using an AR device, and this system sends heated air, which is heated by a heater, to the eyes.

A problem a user experiences in continuous use an XR device is that eyestrain accumulates due to viewing of a display for a long period of time. Warming the eyeballs is effective in recovering from eyestrain of the user.

However, recovery from eyestrain of the user may not be sufficient in the case of the system disclosed in Japanese translation of PCT Application No. 2018-509983.

### SUMMARY OF THE INVENTION

With the foregoing in view, it is an object of the present disclosure to provide a display device which allows the user to recover from eyestrain, and a control method of the display device.

According to some embodiments, a display device includes a casing; a display unit that is disposed in the casing; a temperature detecting unit configured to detect temperature on a front face side, where an image is displayed, of the display unit; an exhaust heat control unit configured to conduct exhaust heat generated on a rear face side of the display unit to the front face side of the display unit; and a temperature control unit configured to control conduction of the exhaust heat by the exhaust heat control unit, based on the temperature detected by the temperature detecting unit.

According to some embodiments, a control method of a display device which includes a casing and a display unit that is disposed in the casing, includes a step of detecting temperature on a front face side, where an image is displayed, of the display unit; a step of conducting exhaust heat generated on a rear face side of the display unit to the front face side of the display unit by an exhaust heat control unit of the display device; and a step of controlling conduction of the exhaust heat by the exhaust heat control unit, based on the detected temperature.

Further features of the present invention will become apparent from the following description of exemplary embodiments with reference to the attached drawings.

### BRIEF DESCRIPTION OF THE DRAWINGS

FIG. 1 is a block diagram depicting a general configuration of a display device according to Embodiment 1.

FIGS. 2A and 2B are schematic diagrams depicting an example of an XR device according to Example 1.

FIGS. 3A and 3B are diagrams depicting an example of the inside of the XR device in a case of not performing eyestrain control according to Example 1.

FIGS. 4A and 4B are diagrams depicting an example of the inside of the XR device in a case of performing eyestrain control according to Example 1.

FIG. 5 is a flow chart of processing executed by the XR device according to Example 1.

FIG. 6 is a schematic diagram depicting an example of an XR device according to Example 2.

FIG. 7 is a diagram depicting an example of the inside of the XR device in the case of not performing eyestrain control according to Example 2.

FIG. 8 is a diagram depicting an example of the inside of the XR device in the case of performing eyestrain control according to Example 2.

FIG. 9 is a flow chart of processing executed by the XR device according to Example 2.

FIGS. 10A and 10B are schematic diagrams depicting an example of an XR device according to Example 3.

FIGS. 11A and 11B are diagrams depicting an example of the inside of the XR device in the case of not performing eyestrain control according to Example 3.

FIGS. 12A and 12B are diagrams depicting an example of the inside of the XR device in the case of performing eyestrain control according to Embodiment 3.

FIG. 13 is a flow chart of processing executed by the XR device according to Example 3.

FIG. 14 is a flow chart of anti-fogging processing executed by the XR device according to Example 3.

### DESCRIPTION OF THE EMBODIMENTS

Preferred embodiments of the present invention will now be described with reference to the accompanying drawings. Configurations indicated in the following embodiments are merely examples, and the present invention is not limited to the illustrated configurations.

### Embodiment 1

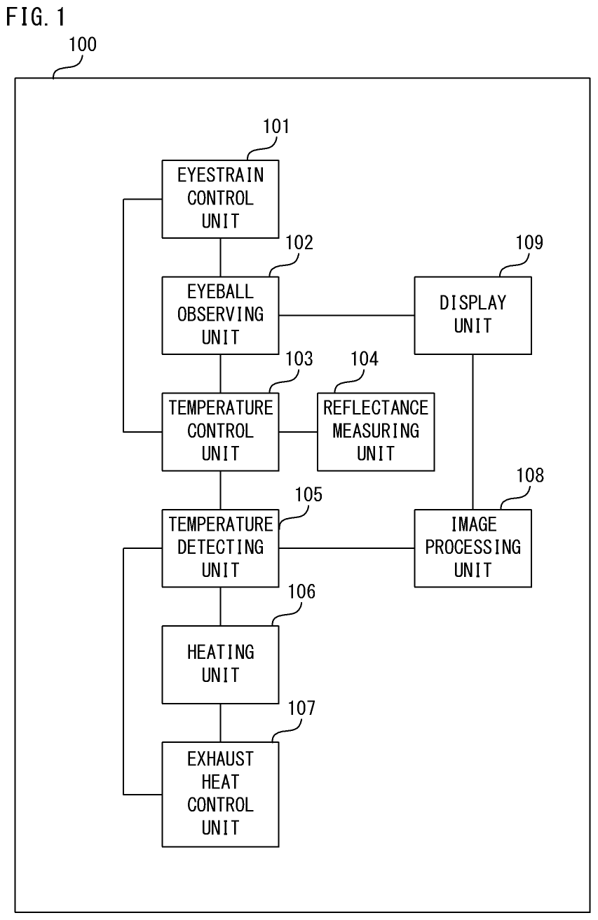

A configuration of a display device according to Embodiment 1 of the present invention will be described with reference to FIG. 1. As indicated in FIG. 1, a display device 100 includes an eyestrain control unit 101, an eyeball observing unit 102, a temperature control unit 103, a reflectance measuring unit 104, a temperature detecting unit 105, a heating unit 106, an exhaust heat control unit 107, an image processing unit 108, and a display unit 109.

In the present embodiment, the display device 100 is a display device having a casing which is mounted on the head of the user, and is applicable to such an XR device as a head mounted display and smart glasses. In terms of improving the accuracy and effect of temperature control, the display device 100 is preferably a sealed type display device, which is an XR device, having a casing configured to cover the periphery of the eyes of the user.

In the case of the display device 100, the display unit 109 displays an image for the user wearing the display device 100. The temperature detecting unit 105 is disposed on the display side (front face side) of the display unit 109, and detects temperature. The exhaust heat control unit 107 conducts exhaust heat on the non-display side (rear face side) of the display unit 109 to areas around the eyes of the user wearing the display device 100. Thereby the temperature in a space covering the eyes of the user inside the display device 100 is controlled.

Now the display device 100 according to the present embodiment will be described in detail using examples. In the following description, the accompanying drawings are referred to, and same composing elements are denoted with a same reference sign through the examples, and redundant description will be omitted. Each example may be changed or combined as required. The configuration, operation and the like of the display device 100 according to the present embodiment are not limited to the following examples.

### Example 1

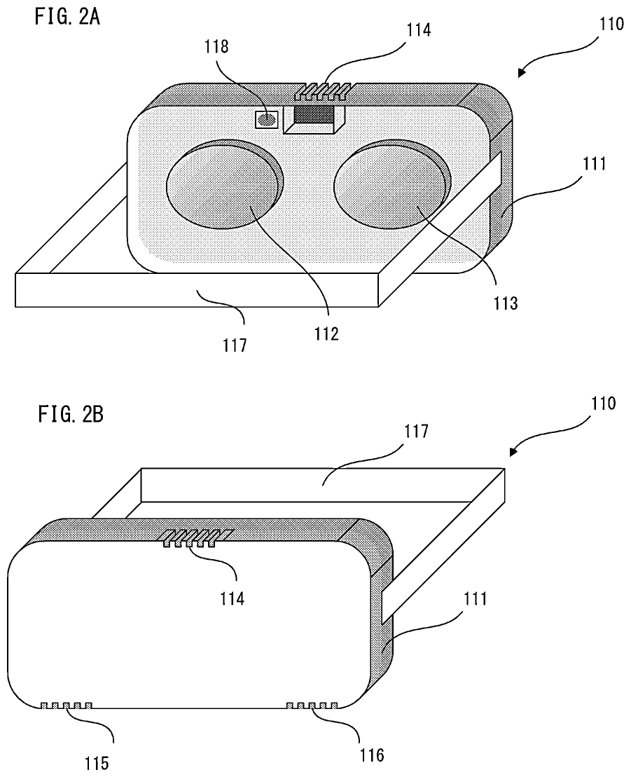

FIGS. 2A and 2B are external views of an XR device 110, which is an example of the display device according to the present embodiment, where FIG. 2A is an external view of the display front face side (user side, image display side), and FIG. 2B is an external view of the display rear side (opposite side of the user, non-display side). In the following description, the display front face side is the side of the front surface of the display unit on which an image is displayed, and the display rear side is the side of the back surface of the display unit. The XR device 110 has a casing 111. Lenses 112 and 113 are disposed on the casing 111 corresponding to displays 124 and 125 constituting the display unit 109, so that the user can view the images displayed on the displays. Vent holes 114, 115 and 116, a holding unit 117, and a temperature sensor 118, constituting the temperature detecting unit 105, are disposed on the casing 111. In Example 1, it is assumed that a medium to convey the exhaust heat generated on the display rear face side inside the XR device 110 is air.

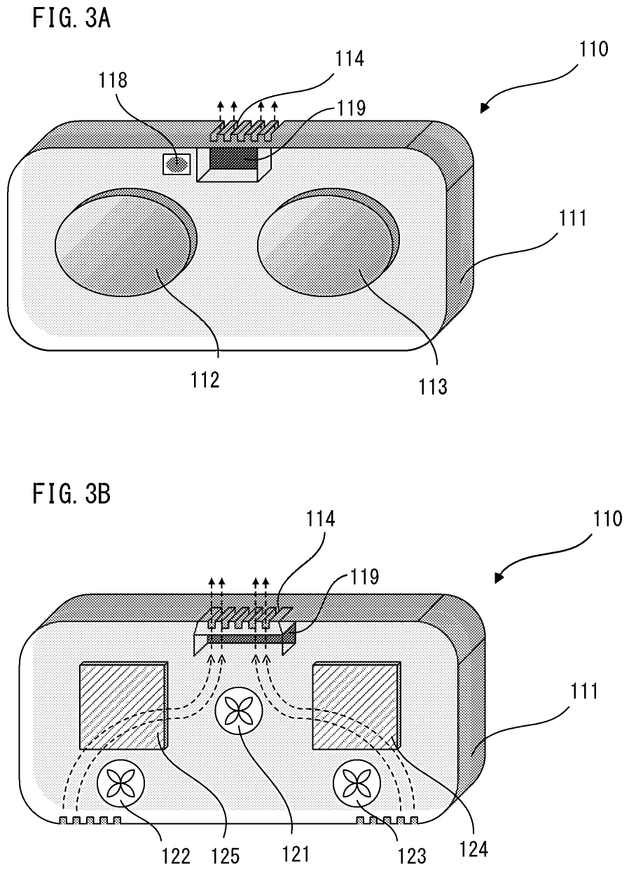

FIGS. 3A and 3B indicate the flow of air inside the casing 111 in a state where control by the eyestrain control unit 101 is no performed (hereafter “non-eyestrain control state”) on the display front face side of the XR device 110 (FIG. 3A), and on the display rear face side of the XR device 110 (FIG. 3B). As indicated in FIG. 3B, three fans, 121, 122 and 123, constituting the exhaust heat control unit 107 are disposed on the display rear face side of the casing 111, to control the circulation of the air in the space on the display rear face side, and to guide the exhaust heat. Further, the display 124 to display an image for a left eye of the user and the display 125 to display an image for a right eye of the user are disposed on the display rear face side. The displays 124 and 125 constitute the display unit 109. In the XR device 110, in the non-eyestrain control state, exhaust heat on the display rear face side due to driving of the displays 124 and 125, is discharged out of the casing 111 via the vent hole 114 using the three fans, 121, 122 and 123.

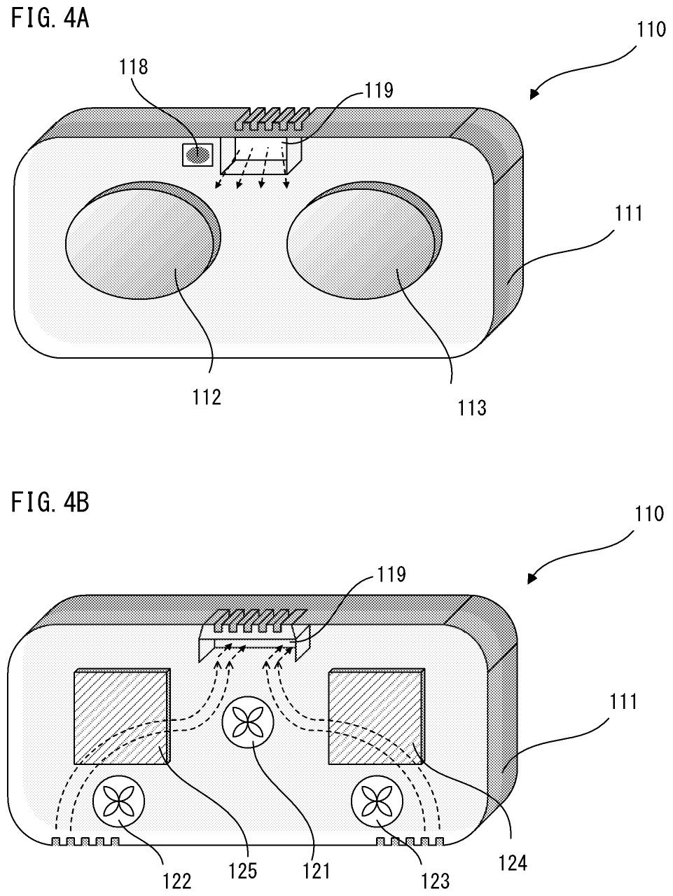

An exhaust heat valve 119, constituting the exhaust heat control unit 107, is disposed in the casing 111 to separate the space on the display front face side and the space on the display rear face side, and to perform the open/close of the vent hole 114. When the exhaust heat valve 119 is at the close position (FIG. 3A and FIG. 3B), the space on the display front face side and the space on the display rear face side do not communicate since the exhaust heat valve 119 separates therebetween. Further, when the exhaust heat valve 119 is at the close position, the vent hole 114 is in the open state. When the exhaust heat valve 119 is at the open position (FIG. 4A and FIG. 4B), on the other hand, the space on the display front face side and the space on the display rear face side communicate. Further, when the exhaust heat valve 119 is at the open position, the vent hole 114 is in the closed state.

FIGS. 4A and 4B indicate the flow of air inside the casing 111 in a state where control by the eyestrain control unit 101 is performed (hereafter “eyestrain control state”) on the display front face side of the XR device 110 (FIG. 4A), and on the display rear face side of the XR device 110 (FIG. 4B). When eyestrain is experienced when the XR device 110 is used, the user manually operates the XR device 110, and enables (turns ON) the eyestrain recovery function of the XR device 110. Selection/cancellation (ON/OFF) of the eyestrain recovery function of the XR device 110 may be performed by a physical button or by a physical switch (not illustrated) disposed on the casing 111. Further, the ON/OFF may be selected using a graphic user interface (GUI) displayed on the displays 124 and 125 of the XR device 110 instead of or in addition to using a physical button or physical switch.

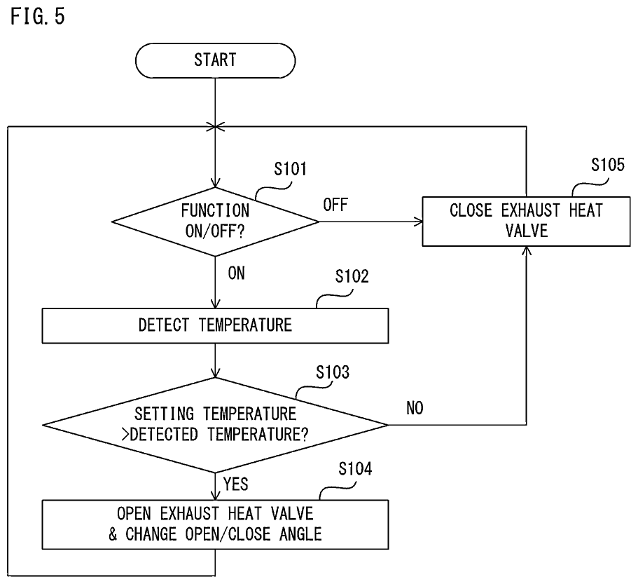

FIG. 5 is a flow chart of processing executed by the XR device 110. As an example, the following processing is executed by the eyestrain control unit 101, which is a central processing unit (CPU), controlling each portion of the XR device 110.

In step S101, the eyestrain control unit 101 determines whether the eyestrain recovery function is enabled (ON) or not (OFF) in the XR device 110. If it is determined that the eyestrain recovery function is enabled (S101: ON), the eyestrain control unit 101 advances processing to step S102. If it is determined that the eyestrain recovery function is not enabled (S101: OFF), the eyestrain control unit 101 advances to step S105. In step S102, the eyestrain control unit 101 transmits a startup signal to the temperature control unit 103. When the startup signal is received, the temperature control unit 103 executes the temperature detection using the temperature detecting unit 105. The temperature detecting unit 105 detects temperature of a space (space of the display front face) between the lenses 112 and 113 of the displays 124 and 125 and the user using the temperature sensor 118. The temperature detecting unit 105 transmits a signal indicating the detected temperature to the temperature control unit 103.

Then in step S103, the temperature control unit 103 refers to the setting temperature, which the user set in advance, and compares the setting temperature and the detected temperature, based on the signal received from the temperature detecting unit 105. If the setting temperature is higher than the detected temperature (S103: YES), the temperature control unit 103 advances processing to step S104. If the setting temperature is the detected temperature or less (S103: NO), the temperature control unit 103 advances processing to step S105.

In step S104, the temperature control unit 103 opens the exhaust heat valve 119 using the exhaust heat control unit 107. In addition, the temperature control unit 103 changes the open/close angle of the exhaust heat valve 119 using the exhaust heat control unit 107. Thereby the exhaust heat generated on the rear face side of the displays 124 and 125 is sent to the front face side of the displays 124 and 125 via the exhaust heat valve 119 (FIGS. 4A and 4B). In step S105, on the other hand, the temperature control unit 103 closes the exhaust heat valve 119 using the exhaust heat control unit 107. Thereby the exhaust heat generated on the rear face side of the displays 124 and 125 is discharged out of the casing 111 via the vent hole 114 (FIGS. 3A and 3B). As a result, the contribution of exhaust heat to the temperature rise on the front face side of the displays 124 and 125 can be reduced.

The setting temperature that the temperature control unit 103 refers to is the temperature which the user selected out of 30° C., 35° C., 40° C., 45° C. and 50° C., for example. The temperature control unit 103 may also refer to the setting temperature that is specified in advance (e.g. 40° C.). The temperature control unit 103 may control the rotation speed (rpm) of the three fans, 121, 122 and 123, independently from the control of the exhaust heat valve of the exhaust heat control unit 107. The exhaust heat control unit 107 performs the open/close operation of the vent hole 114 disposed on the upper portion of the casing 111 using the exhaust heat valve. Thereby the exhaust heat generated on the rear face side of the display unit 109 is sent to a space between the lenses 112 and 113 and the eyes of the user, using air as the medium of the heat. In Example 1, the exhaust heat valve 119 to close the vent hole 114, as the exhaust heat control unit 107, is disposed only for the vent hole 114, but the exhaust heat valve may be disposed for other vent holes to perform exhaust heat control.

In a case where the user manually cancelled the eyestrain recovery function or in a case where the power supply of the XR device 110 is turned OFF, the eyestrain control unit 101 sends a stop signa, to stop the temperature control, to the temperature control unit 103. When the stop signal is received, the temperature control unit 103 closes the exhaust heat valve 119 of the exhaust heat control unit 107. Thereby the space on the front face side of the displays 124 and 125 and the space on the rear face side of the displays 124 and 125 no longer communicate.

As described above, the temperature control unit 103 controls the open/close state of the exhaust heat valve 119 of the exhaust heat control unit 107, and/or the rotation speed of the fans 121, 122 and 123, in accordance with the level of difference between the setting temperature and the detected temperature. Thereby the temperature control unit 103 performs control such that the detected temperature by the temperature detecting unit 105 can be maintained to around the setting temperature. As a result, the space around the eyes of the user wearing the XR device 110 is heated, and promotion of recovery from eyestrain is expected.

### Example 2

Now an XR device 120 will be described as an example of the display device according to Example 2 of the present embodiment. In the following description, a composing element the same as the XR device 110 described above is denoted with a same reference sign, and detailed description thereof will be omitted.

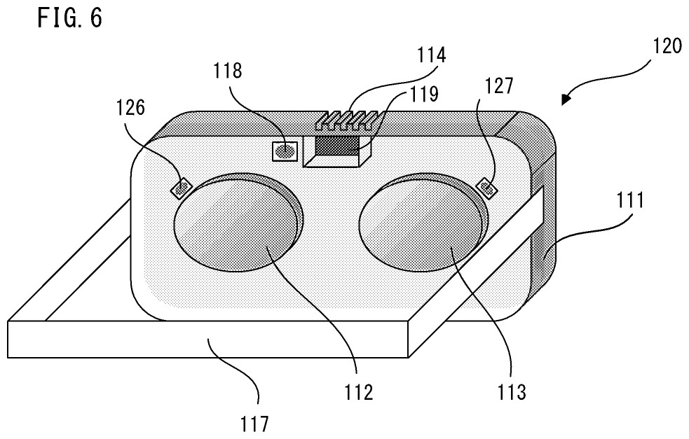

FIG. 6 is an external view of the XR device 120 on the display front face side (front surface side of the display unit) according to Example 2. As illustrated in FIG. 6, line-of-sight sensors 126 and 127, constituting an eyeball observing unit 102, are disposed in the casing 111. The eyeball observing unit 102 is an acquiring unit which acquires information on the movement of the eyeballs of the user wearing the XR device 120. The configuration of the XR device 120 on the display rear face side and the external view thereof are the same as those of the XR device 110 (FIG. 2B).

In Example 2, the line-of-sight sensor 126 tracks the movement of the left eye of the user wearing the XR device 120, for example, to detect a line-of-sight, and determines a position on the display 124 at which the line-of-sight of the left eye is directed. Further, the line-of-sight sensor 127 tracks the movement of the right eye of the user wearing the XR device 120, for example, to detect a line-of-sight, and determines a position on the display 125 at which the line-of-sight of the right eye is directed. The eyestrain control unit 101 reduces the eyestrain of the user using the information on the movement of the eyeballs of the user acquired by the line-of-sight sensors 126 and 127.

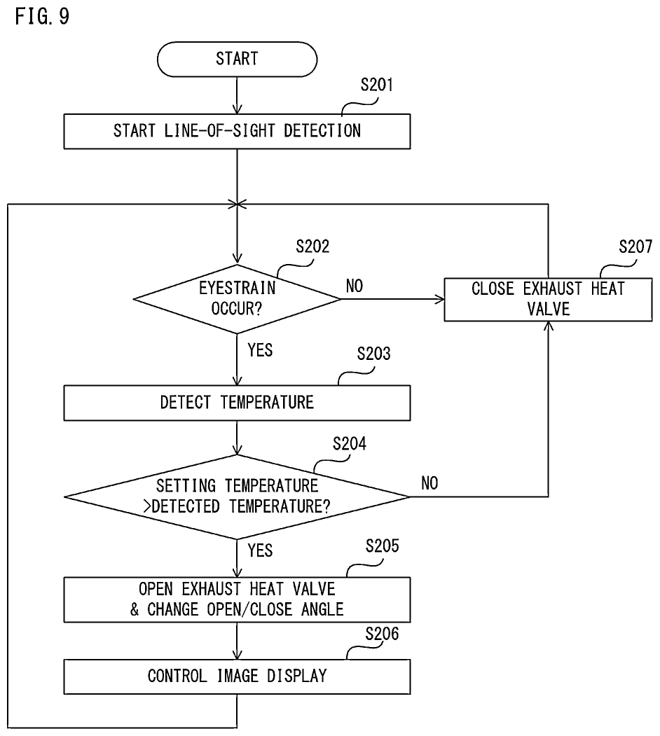

FIG. 9 is a flow chart of processing executed by the XR device 120. For example, the following processing is executed by the eyestrain control unit 101, which is the CPU, controlling each portion of the XR device 120.

In step S201, the eyestrain control unit 101 starts the line-of-sight detection by the line-of-sight sensors 126 and 127. Then in step S202, based on the information on the movement of the eyeballs of the user acquired by the line-of-sight sensors 126 and 127, the eyestrain control unit 101 determines whether eyestrain occurs to the user. Here the eyestrain control unit 101 is a determining unit that determines whether eyestrain occurs to the user based on the information on the movement of the eyeballs of the user acquired by the acquiring unit.

Specifically, when the user performs initial setting of the XR device 120 via the GUI of a startup screen, which is displayed on the displays 124 and 125 at the start of driving the XR device 120, the response speeds of the line-of-sights of the user are calculated by the line-of-sight sensors 126 and 127. For example, the image processing unit 108 displays dialog boxes, to prompt selection of the setting temperature, at the centers of the displays 124 and 125, and then displays the setting temperature selection screens on the displays 124 and 125. At this time, the line-of-sight sensors 126 and 127 measure the response speeds of the line-of-sights when the line-of-sights of the user move from the dialog boxes to the setting temperature selection screens.

For another example, the temperature control unit 103 records the continuous driving time of the XR device 120 from the start of driving. In the XR device 120, the driving time is displayed in the upper right regions of the displays 124 and 125, for example, every time a predetermined time (e.g. 30 minutes) has elapsed since the start of driving, so that the user knows the operation time of the XR device 120. The timing of starting measurement of the continuous driving time can be determined arbitrarily, such as a timing when the power of the XR device is turned ON, or when the display is started on the displays 124 and 125. The line-of-sight sensors 126 and 127 measure the response speeds of the line-of-sights when the line-of-sights of the user move from the current position to the driving time display screen.

Then the eyestrain control unit 101 compares the measured response speeds of the line-of-sights with the response speeds of the line-of-sights of the user measured when driving started, and determines whether eyestrain occurs to the user based on this comparison results.

If it is determined that eyestrain occurs to the user (S202: YES), the eyestrain control unit 101 advances processing to step S203. If it is determined that eyestrain does not occur to the user (S202: NO), on the other hand, the eyestrain control unit 101 advances to processing to step S207. In Example 2, the processing contents of steps S203, S204, S205 and S207 are the same as steps S102, S103, S104 and S105 of Example 1 respectively.

The setting temperature that the temperature control unit 103 refers to is the temperature which the user selected out of 30° C., 35° C., 40° C., 45° C. and 50° C., for example. The temperature control unit 103 may refer to a setting temperature (e.g. 40° C.) that is specified in advance. The temperature control unit 103 may control the rotation speed (rpm) of the three fans 121, 122 and 123 independently from control of the exhaust heat valve of the exhaust heat control unit 107. The exhaust heat control unit 107 performs the open/close operation of the vent hole 114 disposed on the upper portion of the casing 111 using the exhaust heat valve 119. Thereby the exhaust heat generated on the rear face side of the display unit 109 is sent to a space between the lenses 112 and 113 and the eyes of the user, using air as the medium of the heat. In Example 2, the exhaust heat valve 119, to close the vent hole 114 as the exhaust heat control unit 107, is disposed only for the vent hole 114, but the exhaust heat valve may be disposed for other vent holes to perform the exhaust heat control.

The temperature control unit 103 controls the open/close state of the exhaust heat valve 119 of the exhaust heat control unit 107 and the rotation speed of the fans 121, 122 and 123, in accordance with the level of difference between the setting temperature and the detected temperature, such that the detected temperature by the temperature detecting unit 105 can be maintained to around the setting temperature.

In Example 2, after the processing in step S205, the temperature control unit 103 controls at least one of the brightness and the duty ratio related to the image display on the display unit 109 in step S206, so that the detected temperature by the temperature detecting unit 105 becomes close to the setting temperature. In addition, the temperature control unit 103 may control the frame rate of the image display. Thereby the temperature control unit 103 can control the exhaust heat generation amount in the space on the rear face side of the XR device 120, due to the displays 124 and 125, which are heat sources. Further, by correlating the control of the open/close operation of the exhaust heat valve 119 and the processing of the image display on the display unit 109, the heat speed in the space inside the XR device 120 can be increased, and temperature maintaining accuracy can be improved. If the temperature in the space inside the XR device 120 is suddenly increased, condensation may be generated in the displays 124 and 125, and the lens 112 and 113, and the like. Hence the temperature control unit 103 may perform the exhaust heat control based on the temperature difference between the detected temperature, which is detected when the temperature control is started, and the setting temperature, so that the heating speed does not exceed the speed that is set in advance.

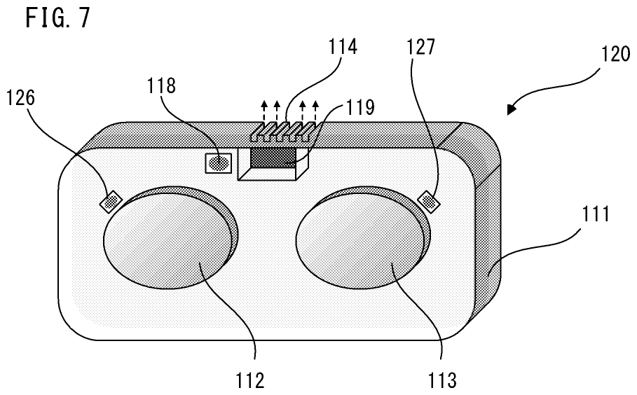

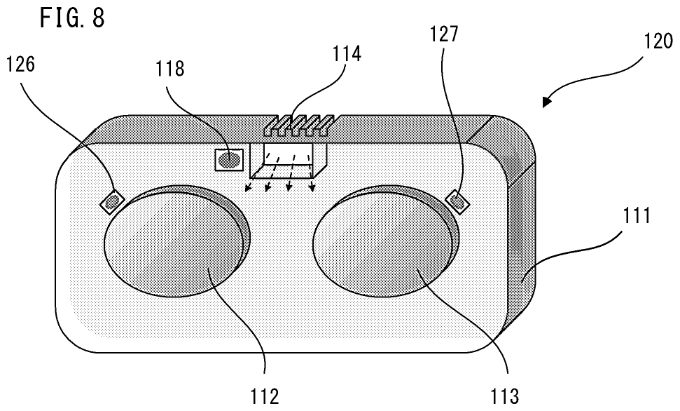

This means that when the exhaust heat valve 119 is in the close position in step S207 (FIG. 7), the exhaust heat generated in the displays 124 and 125 is discharged out of the casing 111 via the vent hole 114. Further, when the exhaust heat valve 119 is in the open position in steps S205 and S206 (FIG. 8), the exhaust heat generated in the displays 124 and 125 is sent to the display front face side. Thereby the space around the eyes of the user wearing the XR device 120 is heated, and promotion of recovery from eyestrain is expected.

In a case where the user manually cancelled the eyestrain recovery function, or in a case where the power supply of the XR device 110 is turned OFF, the eyestrain control unit 101 sends a stop signal, to stop the temperature control, to the temperature control unit 103. When the stop signal is received, the temperature control unit 103 closes the exhaust heat valve 119 of the exhaust heat control unit 107. Thereby the space on the front face side of the displays 124 and 125 and the space on the rear face side of the displays 124 and 125 no longer communicate. Further, after the temperature control unit 103 starts the temperature control, the eyestrain control unit 101 acquires the result of measuring the response speed of the line-of-sights by the line-of-sight sensors 126 and 127 at predetermined intervals. In a case where the eyestrain control unit 101 determined that the response speed has improved to a threshold to determine that the eyestrain does not occur to the user based on the measurement result, the eyestrain control unit 101 may stop the temperature control by the temperature control unit 103.

### Example 3

Now an XR device 130 will be described as an example of the display device according to Example 3 of the present embodiment. In the following description, a composing element the same as the XR devices 110 and 120 described above is denoted with a same reference sign, and detailed description thereof will be omitted.

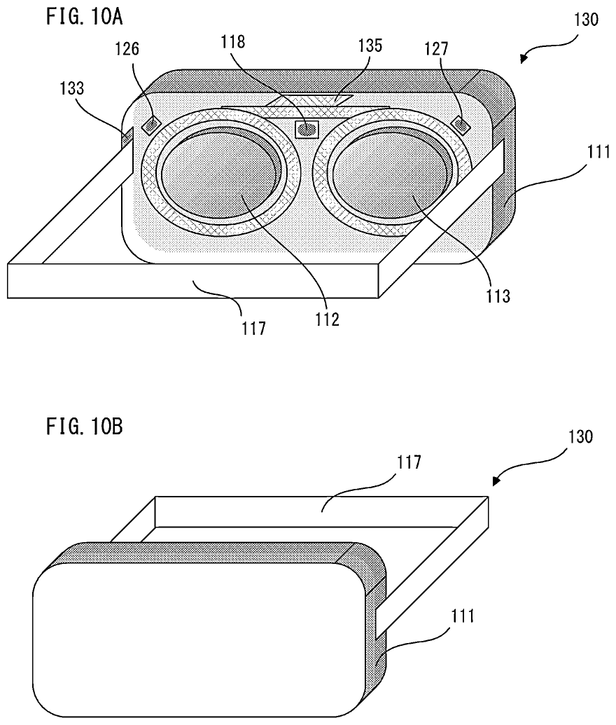

FIGS. 10A and 10B are external views of the XR device 130 according to Example 3, where FIG. 10A is an external view of the display front face side (front surface side of the display unit), and FIG. 10B is an external view of the display rear face side (rear surface side of the display unit). As illustrated in FIG. 10A, in the casing 111 of the XR device 130, lenses 112 and 113 installed on the displays 124 and 125, the holding unit 117, the temperature sensor 118 constituting the temperature detecting unit 105, and the line-of-sight sensors 126 and 127, are disposed. Further, a reflectance measuring unit 133 and a heat conducting unit 135 are disposed in the casing 111.

The heat conducting unit 135 (e.g. aluminum oxide) is a medium to conduct the exhaust heat generated on the rear face side of the displays 124 and 125. Out of the portion constituting the heat conducting unit 135, a portion surrounding the periphery of the lenses 112 and 113 is formed of a soft material, such as rubber having high heat conductivity.

In the XR device 130 of Example 3, the reflectance measuring unit 133, to measure the reflectance of the light of the lenses 112 and 113, is disposed on the display front face side (FIG. 10A). The reflectance measuring unit 133 emits light to the surfaces of the lenses 112 and 113, receives reflected light from each of the lenses 112 and 113, and calculates the reflectance based on the quantity of the received light. Based on the calculated reflectance, the reflectance measuring unit 133 determines whether a fogged state is generated in the lenses 112 and 113 respectively.

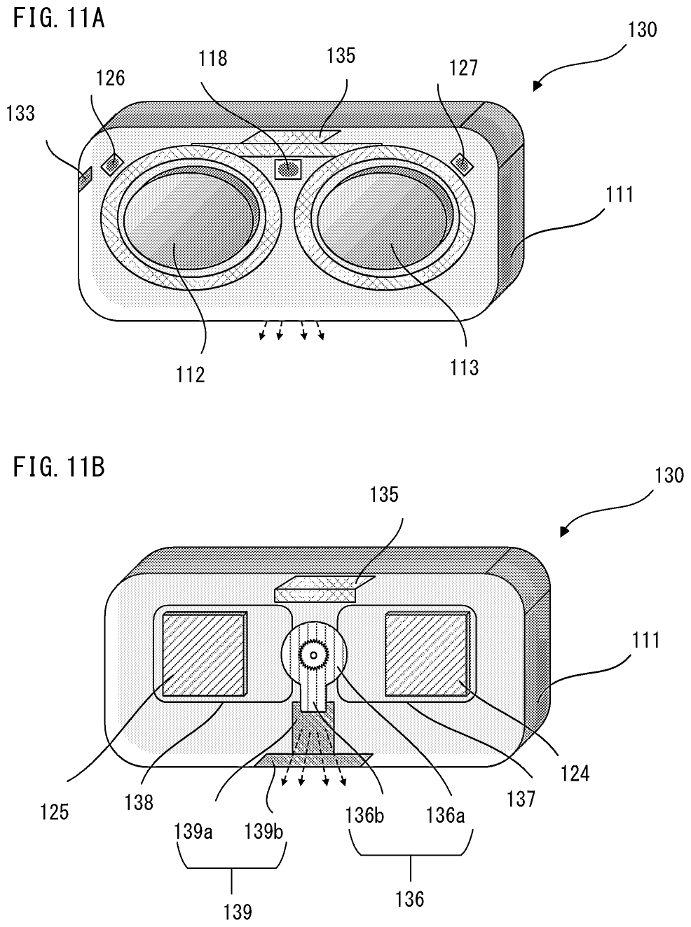

FIGS. 11A and 11B are conceptual diagrams of the XR device 130, where FIG. 11A is the display front face side, and FIG. 11B is the display rear face side, depicting the heat conduction of the exhaust heat of the casing 111 when eyestrain control is not performed. As illustrated in FIG. 11B, on the display rear face side of the casing 111, the displays 124 and 125 are disposed on heat radiating plates 137 and 138 respectively, to conduct the exhaust heat generated by driving the display 124 and 125. Further, a movable unit 136 is disposed so as to partially overlap with the heat radiating plates 137 and 138 and come in contact with the heat radiating plates 137 and 138.

On the display rear face side of the casing 111, a heat conducting unit 139 is disposed on the opposite side of the heat conducting unit 135 across the movable unit 136. The heat conducting unit 139 includes a rectangular portion 139a which is contactable with the movable unit 136 and extends to the outer periphery of the casing 111, and an exposed portion 139b which is connected with the rectangular portion 139a, and constitutes a part of the outer peripheral surface of the casing 111. When contacting with the movable unit 136, the heat conducting unit 139 conducts the heat from the movable unit 136 from the rectangular portion 139a to the exposed portion 139b.

In Example 3, the heat radiating plates 137 and 138 are a first heat conducting unit that conducts the exhaust heat of the display unit 109, and the heat conducting unit 135 is a second heat conducting unit disposed on the front surface side of the display unit 109. The movable unit 136 is a switching unit that is connected with the first heat conducting unit and switches connection with the second heat conducting unit.

In order to efficiently perform heat conduction of the exhaust heat of the displays 124 and 125, grease or an adhesive sheet having high heat conductivity is disposed between the displays 124 and 125 and the heat radiating plates 137 and 138. Further, the movable unit 136 includes a disk portion 136a which overlaps and contacts with the heat radiating plates 137 and 138, and a rectangular protruding portion 136b which extends from the outer periphery of the disk portion 136a to the outside. The disk portion 136a is rotatable around a rotary shaft at the center of the circle of the disk portion 136a. The protruding portion 136b is disposed so as to contact with the heat conducting unit 135 or the heat conducting unit 139 when the disk portion 136a rotates. In FIG. 11B, the movable unit 136 is in contact with the heat radiating plates 137 and 138 and the heat conducting unit 139. Thereby the exhaust heat generated in the displays 124 and 125 is discharged out of the casing 111 via the heat radiating plates 137 and 138, the movable unit 136 and the heat conducting unit 139.

In the state illustrated in FIGS. 11A and 11B, the movable unit 136 contacts with the heat conducting unit 139 without contacting with the heat conducting unit 135. Therefore when the eyestrain control is not performed, the exhaust heat, generated on the display rear face side by driving the displays 124 and 125, is discharged out of the casing 111 from the exposed portion 139b via the heat radiating plates 137 and 138, the movable unit 136, and the heat conducting unit 139. The broken line arrow marks in FIGS. 11A and 11B schematically indicate how the exhaust heat, generated on the display rear face side, is discharged out of the casing 111 via the heat conducting unit 139.

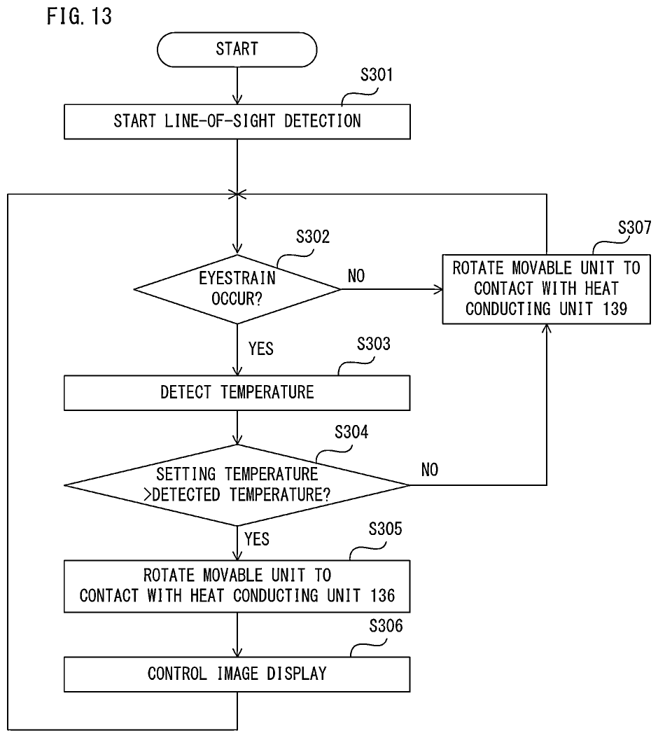

FIG. 13 is a flow chart of processing executed by the XR device 130. For example, the following processing is executed by the eyestrain control unit 101, which is the CPU, controlling each portion of the XR device 130. The processing contents of steps S301, S302, S304 and S306 are the same as those of steps S201, S202, S204 and S206 respectively. In the following, the processing contents of steps S303, S305 and S307 will be described in detail.

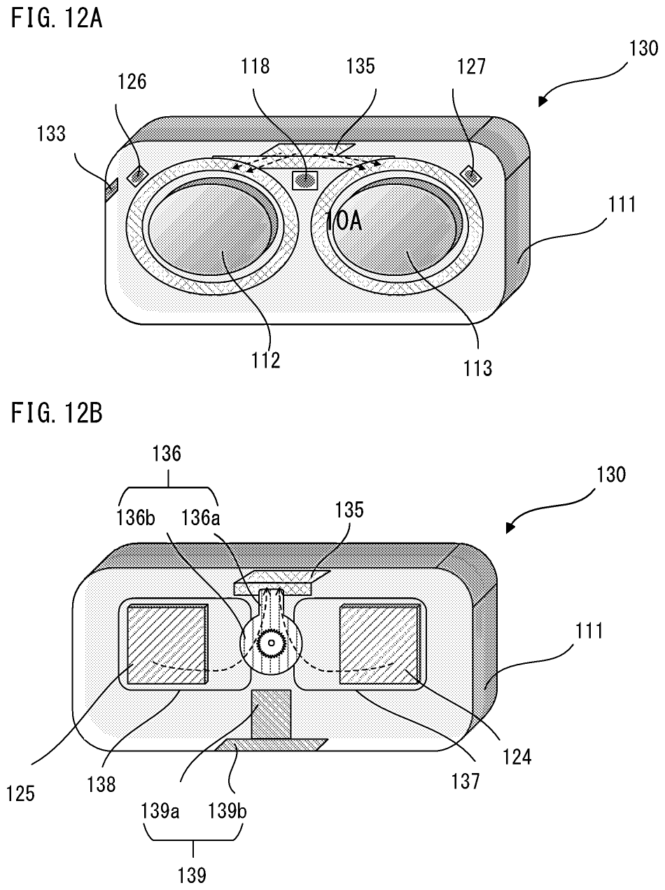

FIGS. 12A and 12B are conceptual diagrams of the XR device 130, where FIG. 12A is the display front face side and FIG. 12B is the display rear face side, depicting the heat conduction of the exhaust heat in the casing 111 when the eyestrain control is performed. When a startup signal is received from the eyestrain control unit 101 in step S303, the temperature control unit 103 executes the temperature detection by the temperature detecting unit 105. In Example 3, the temperature detecting unit 105 detects a temperature of the heat conducting unit 135, more specifically, a temperature of a soft heat conductive material, such as rubber, disposed around the lenses 112 and 113.

If the setting temperature is higher than the detected temperature (S304: YES), the temperature control unit 103 rotates the movable unit 136 by the exhaust heat control unit 107 in step S305, so that the movable unit 136 contacts with the heat conducting unit 135 (FIGS. 12A and 12B). Thereby the exhaust heat generated in the displays 124 and 125 is conducted to the heat conducting unit 135 through the heat radiating plates 137 and 138 via the movable unit 136. As a result, the portion of the heat conducting unit 135 surrounding the lenses 112 and 113 is heated, the space around the eyes of the user wearing the XR device 130 is heated, and promotion of recovery from the eyestrain is expected.

In step S307, on the other hand, the temperature control unit 103 rotates the movable unit 136 by the exhaust heat control unit 107, so that the movable unit 136 contacts with the heat conducting unit 139 (FIGS. 11A and 11B). Thereby the exhaust heat generated in the displays 124 and 125 is conducted to the heat conducting unit 139 through the heat radiating plates 137 and 138 via the movable unit 136. As a result, the exhaust heat generated in the displays 124 and 125 is discharged out of the casing 111 via the heat conducting unit 139.

The setting temperature that the temperature control unit 103 refers to is the temperature which the user selected out of 30° C., 35° C., 40° C., 45° C. and 50° C., for example. The temperature control unit 103 may also refer to the setting temperature that is specified in advance (e.g. 40° C.). The temperature control unit 103 may control the contact between the movable unit 136 and the heat conducting units 135 and 139 in accordance with the level of difference between the setting temperature and the detected temperature, such that the detected temperature can be maintained to around the setting temperature.

In Example 3, the temperature control unit 103 changes the brightness, frame rate and the like of images displayed on the display unit 109 by the image processing unit 108, so that the detected temperature by the temperature detecting unit 105 becomes close to the setting temperature. Thereby the temperature control unit 103 can control the exhaust heat generation amount in the space on the rear face side of the XR device 130, due to the displays 124 and 125, which are heat sources. Further, by correlating the control of the open/close operation of the exhaust heat valve 119 and the processing of the image display on the display unit 109, the heating speed in the space inside the XR device 130 can be increased, and the temperature maintaining accuracy can be improved. If the temperature in the space inside the XR device 130 is suddenly increased, condensation may be generated in the displays 124 and 125, the lenses 112 and 113, and the like. Hence the temperature control unit 103 may perform the exhaust heat control based on the temperature difference between the detected temperature, which is detected when the temperature control is started, and the setting temperature, so that the heating speed does not exceed the speed that is set in advance.

In a case where the user manually cancelled the eyestrain recovery function, or in a case where the power supply of the XR device 130 is turned OFF, the eyestrain control unit 101 sends a stop signal, to stop the temperature control, to the temperature control unit 103. When the stop signal is received, the temperature control unit 103 closes the exhaust heat valve 119 of the exhaust heat control unit 107. Thereby the space on the front face side of the displays 124 and 125 and the space on the rear face side of the displays 124 and 125 no longer communicate. Further, after the temperature control unit 103 starts the temperature control, the eyestrain control unit 101 acquires the result of measuring the response speed of the line-of-sights by the line-of-sight sensors 126 and 127 at predetermined intervals. In a case where the eyestrain control unit 101 determines that the response speed has improved to a threshold, to determine that the eyestrain does not occur to the user based on the measurement result, the eyestrain control unit 101 may stop the temperature control by the temperature control unit 103.

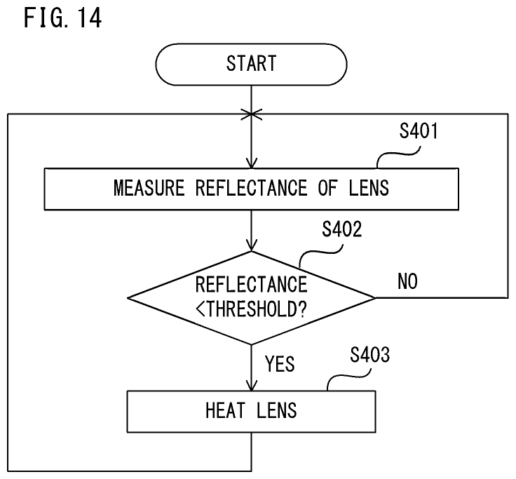

Now an anti-fogging function of the lenses 112 and 113, executed in the XR device 130, will be described with reference to the flow chart in FIG. 14. The fogging state of the lenses 112 and 113 is generated when the difference between the ambient temperature and the temperature of the displays is large. Hence the heating processing of the present flow chart, to prevent fogging of the lenses 112 and 113, can be performed independently from the processing to recover the eyestrain of the user of the flow chart in FIG. 13.

In step S401, the reflectance measuring unit 133 emits light to the lenses 112 and 113, receives the reflected light thereof, and calculates the reflectance of the light of the lenses 112 and 113 respectively based on the light quantity of the reflected light. Then in step S402, the reflectance measuring unit 133 compares the calculated reflectance with a threshold, so as to determine whether the fogging state is generated in the lenses 112 and 113. The reflectance measuring unit 133 determines that the fogging state is generated in the lenses if the calculated reflectance is less than the threshold. If it is determined that the fogging state is generated in at least one of the lenses 112 and 113 (S402: YES), the reflectance measuring unit 133 sends a startup signal to the temperature control unit 103. If it is determined that the fogging state is not generated in either of the lenses 112 and 113 (S402: NO), the reflectance measuring unit 133 returns the processing back to step S401. Then if the startup signal is received from the reflectance measuring unit 133 in step S403, the temperature control unit 103 controls the heating unit 106 to heat the lenses 112 and 113, so as to clear the fogging state.

The selection/cancellation (ON/OFF) of the anti-fogging function of the lenses 112 and 113 of the XR device 130 may be performed by operating a physical button or a physical switch on the casing 111 when the user experiences fogging of the lenses 112 and 113, for example. Instead of or in addition to this, the selection/cancellation of the anti-fogging function of the lenses 112 and 113 may be performed based on the operation of the GUI of the XR device 130.

In the case of a sealed type display device, such as the XR device 130 of Example 3, the XR device 130 may be applied to underwater goggles, for example, and in this case, the casing 111 is configured to have a waterproof structure for the space between the casing 111 and the user. Thereby the XR device 130, to which waterproof performance is added for the space between the casing 111 and the user, can be provided. As a result, when a user wearing the XR device 130 performs underwater diving, information to assist the underwater actions of the user can be displayed on the displays 124 and 125. Further, in the underwater diving, the user cannot easily attach/detach the XR device 130, hence the XR device 130 can be an ideal display device with the above mentioned eyestrain recovery function and the anti-fogging function for the lenses.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, a display device which allows the user to recover from eyestrain and a control method of the display device can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-184704, filed on Oct. 27, 2023, which is hereby incorporated by reference herein in its entirety.

What is claimed is:

1. A display device, comprising:
a casing;
a display unit that is disposed in the casing;
a temperature detecting unit configured to detect temperature on a front face side, where an image is displayed, of the display unit;
an exhaust heat control unit configured to conduct exhaust heat generated on a rear face side of the display unit to the front face side of the display unit; and
a temperature control unit configured to control conduction of the exhaust heat by the exhaust heat control unit, based on the temperature detected by the temperature detecting unit.

2. The display device according to claim 1, wherein
the exhaust heat control unit includes a valve that separates a space on the front face side of the display unit and a space on the rear face side of the display unit, and
the exhaust heat control unit conducts the exhaust heat to the front face side of the display unit by opening/closing the valve.

3. The display device according to claim 1, wherein
the exhaust heat control unit includes a first heat conducting unit configured to conduct the exhaust heat, a second heat conducting unit disposed on the front face side of the display unit, and a switching unit that is connected with the first heat conducting unit and switches connection with the second heat conducting unit, and
the exhaust heat control unit conducts the exhaust heat to the front face side of the display unit by the switching unit switching the connection with the second heat conducting unit.

4. The display device according to claim 1, further comprising:
an acquiring unit configured to acquire information on movement of eyeballs of a user of the display device; and
a determining unit configured to determine whether eyestrain occurs to the user, based on the information acquired by the acquiring unit, wherein
in a case where the determining unit determines that eyestrain occurs to the user, the temperature control unit allows the exhaust heat control unit to conduct the exhaust heat to the front face side of the display unit.

5. The display device according to claim 4, wherein
the information on the movement of the eyeballs of the user is information on response speed of line-of-sights of the user.

6. The display device according to claim 4, wherein
in a case where the determining unit determines that eyestrain does not occur to the user, the temperature control unit stops the exhaust heat control unit from conducting the exhaust heat to the front face side of the display unit.

7. The display device according to claim 1, wherein
the temperature control unit controls a generation amount of the exhaust heat by controlling at least one of brightness and a duty ratio related to the image display on the display unit.

8. The display device according to claim 1, further comprising:
lenses configured for a user of the display device to view an image displayed on the display unit;
a reflectance measuring unit configured to measure reflectance of the lenses; and
a heating unit configured to heat the lenses, wherein
the temperature control unit controls heating of the lenses by the heating unit, based on the reflectance of the lenses measured by the reflectance measuring unit.

9. The display device according to claim 1, wherein
the casing has a shape covering areas around eyes of a user of the display device.

10. The display device according to claim 9, wherein
the casing has a waterproof structure for a space between the casing and the user.

11. A control method of a display device which includes a casing and a display unit that is disposed in the casing, the control method comprising:
a step of detecting temperature on a front face side, where an image is displayed, of the display unit;
a step of conducting exhaust heat generated on a rear face side of the display unit to the front face side of the display unit by an exhaust heat control unit of the display device; and
a step of controlling conduction of the exhaust heat by the exhaust heat control unit, based on the detected temperature.

12. A non-transitory computer readable medium that stores a program, wherein the program causes a computer to execute a control method of a display device which includes a casing and a display unit that is disposed in the casing, the control method comprising:
a step of detecting temperature on a front face side, where an image is displayed, of the display unit;
a step of conducting exhaust heat generated on a rear face side of the display unit to the front face side of the display unit by an exhaust heat control unit of the display device; and
a step of controlling conduction of the exhaust heat by the exhaust heat control unit, based on the detected temperature.
